(19) United States
(12) Patent Application Publication
(10) Pub. No.: US 2003/0057823 A1
(43) Pub. Date: Mar. 27, 2003

(54) Cathode-ray tube

(76) Inventors: Shin-ichiro Hatta, Nara-shi (JP); Ryuichi Murai, Toyonaka-shi (JP); Hiroshi Iwamoto, Osaka-shi (JP); Shigeo Nakatera, Hirakata-shi (JP); Tetsuro Ozawa, Ibaraki-shi (JP)

Correspondence Address: Parkhurst & Wendel, Suite 210, 1421 Prince Street, Alexandria, VA, 22314-2805, US

(21) Appl. No.: 10/168,497

(22) PCT Filed: Dec. 19, 2000
(86) PCT No.: PCT/JP00/09008

(30) Foreign Application Priority Data
Dec. 28, 1999 (JP) 11-373175

(51) Int. Cl. H01J 29/46

(52) U.S. Cl. 313/479

(57) ABSTRACT

The distribution of magnetic field of the terrestrialmagnetism is complicated. Thus, it is difficult to compensate the deviation of the arrival point of the electron beam onto the fluorescent material plane due to the influence of external magnetic field such as the terrestrialmagnetic field, when only an inner magnetic shield and a mask are installed in a flat type color CRT to avoid such influence, in certain regions on the earth, where such CRT is used. The first countermeasure of the influence is using of a stripe type color cathode ray tube, which has a large allowance to the deviation of the arrival point of the electron beam in the vertical direction. Next countermeasure is disposing of a filler made from non-magnetic material or hard magnetic material and/or a gap between the inner magnetic shield and the frame of the mask so as to flow out the magnetic flux, which come from the edge of inner magnetic shield and tend to flow into the inside space of the mask.

### TECHNICAL FIELD

The present invention relates to a cathode ray tube, and in particular to a technology for compensating the deviation of the electron beam due to an external magnetic field.

### BACKGROUND ART

### General Background Art

A cathode ray tube is used in, for example, a color television. In a cathode ray tube, electrons are emitted from an electron gun therein. The emitted electrons collide with a fluorescent material plane, which is disposed on the inner surface of the front display screen of the cathode ray tube. The fluorescent body emits a light, so as to display something on the screen, when the electrons collide therewith. Since there is a magnetic field in everywhere on the earth, the magnetic field effects the motion of the electron. The electron trajectory will be distorted due to the influence of the magnetic field, when the magnetic field is not compensated. As a result, the arrival point of the electron in the fluorescent plane will deviate from the intended point, which will cause, in particular in a color television, a mackle in the screen and a blur and/or lack of uniformity of color. The blur and/or lack of uniformity of color can be caused also by an artificial magnetic field, which will be found in a location such as in a ship, near to a steel work or under a high voltage line. Although such a case may be rare, it must be considered in designing a cathode ray tube.

The influence of the terrestrialomagnetic field relates directly to the present invention. Thus it is concisely explained below, nevertheless it is a well known fact.

The inner space of a cathode ray tube is usually magnetically shielded by an inner magnetic shield. When the terrestrialmagnetic field invades into the space inside the inner magnetic shield, the electron beam is influenced by a Lorentz force f due to the magnetic field. The Lorentz force f is given by

f=q(v×B)

where f is a force acting on the electron, q (<0) is the charge of the electron, v is the velocity vector of the electron and B is a magnetic flux density. As a result, the arriving point of the electrons onto the display screen deviates from the intended point. The direction of the deviation is same to the Lorentz force direction.

Thus, the conventional cathode ray tube includes an inner magnetic shield and a mask in order to compensate the influence of the terrestrialmagnetic field. The influence of other magnetic field, for example, a magnetic field generated by the television receiver tuner itself is negligible. The inner magnetic shield and the mask are disposed in a glass tube of the cathode ray tube, which is so-called “Braun tube”. The inner magnetic shield has a rectangular cross section, the size of which increases along the axial direction of the tube, starting from the electron gun portion to the display screen portion. The mask is disposed at the inside of the fluorescent material plane, namely at the electron gun side of the fluorescent material plane, and is configured to be parallel to the fluorescent material plane. They are shown in FIG. 1.

In FIG. 1, the reference numeral 1 denotes a glass tube which constitutes an outer wall of the cathode ray tube body. The reference numeral 10 is a fluorescent material plane and is disposed on the inner surface of the display screen of the glass tube. The fluorescent material plane is formed by fluorescent materials disposed thereon. The fluorescent plane 10 has a so-called stripe structure. In the stripe structure, a vertical band 12 of fluorescent materials for red (R), a band 13 for green (G) and a band 14 blue (B) are formed. Each of which has a width in the vertical direction of about 150 μm. The stripes comprised of the bands are repeatedly disposed. A black matrix 11 is inserted between each repeating unit of the stripes. The black matrix 11 has a width in vertical direction of about 180 μm. The details of the stripes and the black matrix are shown in the enlarged circle at the right side of FIG. 1.

The reference numeral 30 denotes an inner magnetic shield and the reference numeral 20 denotes a mask, and the mask 20 is held by a mask frame 25. Reference numeral 110 denotes a magnetic field parallel to the axial direction of the tube, which is perpendicular to the display screen and is horizontal. Reference numeral 100 denotes a transverse magnetic field perpendicular to the axial direction of the tube and is horizontal. Reference numeral 120 denotes a vertical magnetic field.

In the description hereinafter, the transverse direction is referred to “X axis”, the axial direction of the tube is referred to “Z axis”, and the vertical direction is referred to “Y axis”. They are shown at the upper portion of FIG. 1. The magnetic field in the X axis and Z axis can be opposite to FIG. 1 by 180 degrees, depending on the configuration of the television receiver set.

Reference numerals 200 and 201 denote respectively an intended trajectory of electron and an intended arrival point of the electron on the fluorescent material plane 10. Reference numerals 2001 and 2011 denotes respectively a distorted trajectory of electron and a deviated arrival point of the electron on the fluorescent material plane 10, without any compensation means.

Although external magnetic fields may be shielded by depositing an extremely thin iron layer on the inner surface of the glass tube, the cathode ray tube according to the present invention does not need such a structure. Instead, the present invention compensates the magnetic field using an inner magnetic shield and a mask. Namely somewhat invasion of the magnetic field into the glass tube is accepted, and the flow of the magnetic flux is regulated so as to decrease the influence of the magnetic field. This strategy is employed, considering the productivity and fabrication cost.

### Background with Respect to the Problem to be Solved

The direction and the magnitude of terrestrialmagnetic field depend strongly on the regional zones on the earth. The horizontal component of the terrestrialmagnetic field in a tropical zone, for example, Malaysia, Indonesia and the regions close to there, is larger than that in Japan (for example Tokyo) by 20% to 70%. Therefore, when such a terrestrialmagnetic field compensating strategy is employed, in which the terrestrialmagnetic field is not completely shut out and somewhat invasion of the magnetism into the glass tube is accepted, the difference of the terrestrialmagnetic field corresponding to the regional zones on the earth must be compensated.

In the conventional cathode ray tube, the display screen is in a so-called curved surface. And the mask is fabricated by a press machine. Thus, the material for the tube is selected from mild steel or like material. Such materials are soft magnetic material, namely, they have a relatively high relative permeability, for example, not less than 1000. Therefore such a magnetic field shielding, even when it has a simple structure, could automatically compensate the terrestrialmagnetic field in the different regional zones on the earth. However, recently, the level of the requirements of consumers and users on the display qualities became high. Therefore, leading display screens of the color television receiver set tend to change from the so-called round surface type to a perfectly flat surface type one.

The flat type display screen has usually a rectangular display screen. The rectangle has usually a diagonal length of, for example, 20 to 30 inches (1 inch is approximately 25.4 mm) and an aspect ratio of about 3 to 4. An aspect ratio is a proportion of the vertical length to the horizontal length of a display screen. And a thin mask must be disposed exactly at the inside of the rectangular display screen; no inequality or no distortion thereof are allowed even at the corners of the rectangle. Thus, it is necessary to employ a structure as shown in FIG. 2(1), using a rectangular steel frame 21 having an L-formed cross section provided at the inside of the display screen 10 for holding a mask 22. The mask 22 must be welded onto thin side surfaces of the steel frame 21 at a tension state. Therefore, the material for the steel frame 21 must be selected from steels containing chromium and/or molybdenum. FIG. 2(2) is a vertical cross sectional view of the frame and the mask, showing that the end of the mask 22 is fixed to the steel frame 21 at the horizontal outer surface of the side (appears as upper in the figure) of the frame, instead of at the vertical outer surface of a side of the frame.

The material for the mask 22 suffers a large tension force due to the structure. As a result of magnetostriction, the relative permeability reduces to a relatively small value, for example, 10 or less. And, it becomes a hard magnetic material which is hardly magnetized by a small magnetic field and its magnetization hardly changes. Therefore, the mask does not perform the automatic compensation function with respect to the change of the terrestrialmagnetic field according to the regional zones on the earth.

Such steel frame does not perform the automatic compensation function also with respect to the disturbance of the magnetic field due to high voltage lines, or being in a ship or steel structure such as a steel work.

The problem may be solved by increasing the acceleration voltage, or by remarkably decreasing the longitudinal length of the glass tube. By the way, the conventional length of the current glass tube is about 10 inches. It is, however, difficult to employ such countermeasures, when the electric power consumption, the life of the fluorescent materials, the area of the display screen and the fabrication cost are considered.

Thus, it is desired to realize a cathode ray tube, especially a flat type color cathode ray tube, which can display beautifully without any mackle or blur, by suitably compensating external magnetic fields, irrespective to the regional zones on the earth or the configuration of the television receiver to be installed, and of course, which is excellent from the viewpoint of productivity and the fabrication cost.

### DISCLOSURE OF THE INVENTION

The inventor studied the distribution and the direction of the magnetic flux in a cathode ray tube, in order to solve the aforementioned problems of the prior art, and attained the cathode ray tube according to the present invention. In the cathode ray tube according to the present invention, the magnetic flux in the inner magnetic shield is guided to the mask, at the fluorescent material plane side at the mask/frame portion. In the case of a stripe type color television receiver, the deviation of the arrival point of the electron in the stripe band direction hardly causes a mackle or blur. This fact is considered in solving the problems. More particularly, the cathode ray tube according to the present invention comprises the following constitution.

The cathode ray tube in the first aspect of the present invention comprises an inner magnetic shield which is made from soft magnetic material, such as soft steel, and is disposed in the glass tube along the axial direction of the tube, which is the substantial motion direction of the electron emitted from the electron gun, the shield size increases to the fluorescent material display screen direction; a frame, which is made from hard magnetic material and is disposed at the side of the fluorescent plane with respect to the inner magnetic shield, (including the case that it is disposed at a little inside of the end portions of the display screen) and is simultaneously disposed at the electron gun side of the display screen; a mask held by the frame; and equalizing means for reducing or equalizing the horizontal deviation of the arrival point of the electron beam onto the display screen, the equalizing means is disposed between the inner magnetic shield and the frame or between the inner magnetic shield and the mask, depending on the holding configuration of the mask by the frame.

The cathode ray tubes in the second and third aspects of the present invention comprises an inner magnetic shield which is made from soft magnetic material, such as soft steel, and is disposed in the glass tube along the axial direction of the tube, which is the substantial direction of the motion of the electron emitted from the electron gun, the size of the shield increases to the fluorescent material display screen direction; a frame, which is made from hard magnetic material and is disposed at the side of the fluorescent plane at the inner side with respect to the inner magnetic shield, namely, (including the case that it is disposed at a little inside of the end portion of the display screen) and is simultaneously disposed at the electron gun side of the display screen; a mask held by the frame; and a structure for magnetic flux leakage to outside, which is a gap (i.e., vacuum) and/or a filler made from non-magnetic material having a relative permeability of 1, such as an aluminum alloy, the structure for magnetic flux leakage to outside has a certain dimension, and is disposed between the inner magnetic shield and the frame or between the inner magnetic shield and the mask (when the mask is fixed at the horizontal upper and lower end portion of the frame). By the way, the notion “the structure for magnetic flux leakage to outside” includes a gap comprised of a simple recessing. And the notion “gap” includes the case that a gap is formed between the inner magnetic shield and mask/frame and they are connected by something such as pins, namely it includes such a case that there are something or materials in the gap for connection thereof.

The magnetic field which has its origin in the terrestrialmagnetism, passes through the cathode ray via the electron gun region and the inner magnetic shield to the center portion of the mask/frame. When the structure for magnetic flux leakage to outside is not provided, the magnetic flux leaks inside the mask, (or a corresponding magnetic flux distribution may be formed), because the frame is made from hard magnetic material. However, according to the present invention, the magnetic flux leaks to outside, namely to the opposite side of the electron gun, due to the structure for magnetic flux leakage to outside. Consequently, the influence of the terrestrialmagnetic field on the trajectory of the electron emitted from the electron gun toward the fluorescent material plane is reduced.

The structure for magnetic flux leakage to outside can be realized also by disposing a certain recess in the inner magnetic shield. It is obvious that the form of such recess can be modified in the scope of the present invention.

In the cathode ray tubes in the fourth and fifth aspects of the present invention, the structure for magnetic field leakage to outside comprises a hard magnetic material such as iron/chromium alloy. Of course, it is possible to dispose a gap at the upper and/or lower side thereof, and/or to use simultaneously a filler made from non-magnetic material referred hereinbefore, which will contribute also to the fixing of the inner magnetic shield and the mask/frame to each other.

In the cathode ray tube in the sixth aspect of the present invention, the relative permeability (magnetic permeability compared to the magnetic permeability of the vacuum) of the hard magnetic material is not less than 1 and not more than 1000 (for example, iron-silicon alloy), preferably not more than 100, more preferably not more than 10 (for example, iron suffered a plastic deformation), most preferably lower than 5. In such a case, the leakage of magnetic flux to the outside of the fluorescent material plane at the connecting portion between the inner magnetic shield and the mask/frame can be enhanced.

In a usual stripe type color displaying cathode ray tube, bands of fluorescent materials for colors of red, green and blue are arranged repeatedly, and a black matrix is inserted between the unit of the repeating set of bands. When the cathode ray tube is designed for use in a tropical zone on the earth, the bands are usually arranged in the vertical direction in the display screen. Thus, a certain deviation of the arrival point of electron onto the display screen in the vertical direction is permissible.

The structure for magnetic flux leakage to outside is disposed only in the direction of the bands of the stripes. According to this structure, the magnetic flux extending in the vertical direction, which influences on the trajectory of the electron in the horizontal direction, is reduced. Therefore, the allowance to the inequality of the distribution of the inner magnetic field or the allowance of the disturbance thereof can be increased.

In the cathode ray tubes in the seventh and eighth aspects of the present invention, the cathode ray tube is a stripe type color displaying cathode ray tube for use of a color television receiver, and a gap is employed as a structure for magnetic flux leakage to outside. The dimensions of the gap is designed to be not less than 0.9% and not more than 1.4% with respect to the dimension of the diagonal of the cathode ray tube, when the proportion of the length of the long side (horizontal side) to the length of the short side (vertical side) of the display screen is 4 to 3. Accordingly, the dimension is about 5.7 to 8.9 mm, preferably 6 to 8 mm, when the diagonal length of the display screen is about 25 inches. In such a case, the leakage of the magnetic flux to the outside can be increased.

In the cathode ray tubes in the ninth to twelfth aspects of the present invention, the cathode ray tube is a flat type one. Accordingly the advantages of the present invention can be obtained in the best form. And color images in the display screen are beautiful, partially owing to being a flat type cathode ray tube.

### BRIEF DESCRIPTION OF THE DRAWINGS

FIG. 1 is a cross sectional view of a conventional cathode ray tube, showing the inner side thereof, the trajectory of electron emitted from an electron gun as well as the structure of the stripes.

FIG. 2 shows a structure of a conventional flat type cathode ray tube, which comprises a simple inner magnetic shield and a mask disposed therein.

FIG. 3 is a schematic diagram of an equivalent magnetic circuit for analyzing the inner magnetic flux in the cathode ray tube such as shown in FIG. 1.

FIG. 4 is a front view of a display screen, showing points where the compensation of the geomagnetism in a cathode ray tube is estimated.

FIG. 5 is a perspective view of an inner magnetic shield (IMS), which has a recess on its side flank.

FIG. 6 is a cross sectional view of a cathode ray tube according to an embodiment of the present invention, showing its essential part.

FIG. 7 is a graph, showing the deviation of the electron beam as a function of filler thickness or gap dimension (values are shown in an arbitrary scale).

Reference Numerals

1 glass tube (outer wall of a cathode ray tube body)

10 fluorescent material plane

11 black matrix

12 Red illuminating portion

13 Green illuminating portion

14 Blue illuminating portion

20 mask in the prior art

21 long side (upper and lower) portion of a frame of mask (according to an embodiment)

210 short side (right and left) portion of a frame of mask (according to an embodiment)

211 cover for the end of the long side portion of a frame of mask

22 mask for a flat type cathode ray tube (according to an embodiment)

23 gap

24 filler

25 frame of mask

30 inner magnetic shield (body)

31 elongated recess

32, 33 other recesses

100 transverse magnetic field

110 axial magnetic field

120 vertical magnetic field

200 intended trajectory of electron

201 intended arrival point of electron

2001 actual trajectory of electron

2011 actual arrival point of electron

221 deviation in transverse-corner

222 deviation in axial-corner

223 deviation in axial-NS

300 source of magnetic flux

301 magnetic resistance of the vacuum

302 magnetic resistance of the (upper and lower) shield

303 magnetic resistance of the (upper and lower) frame

304 magnetic resistance at the welding point

305 additional magnetic resistance due to the elongation of the mask

306 magnetic resistance of the (upper and lower) mask

310 ground (the center portion of the tube axis)

350 South East corner of the display screen

351 NS of the display screen

### BEST MODE FOR CARRYING OUT THE INVENTION

The invention will be better understood by way of the following detailed description of a preferred embodiment with reference to the appended drawings. For better understanding, at first, the principal idea of the invention and the method of the magnetic field analysis are explained, before explaining the cathode ray tube according to the present invention.

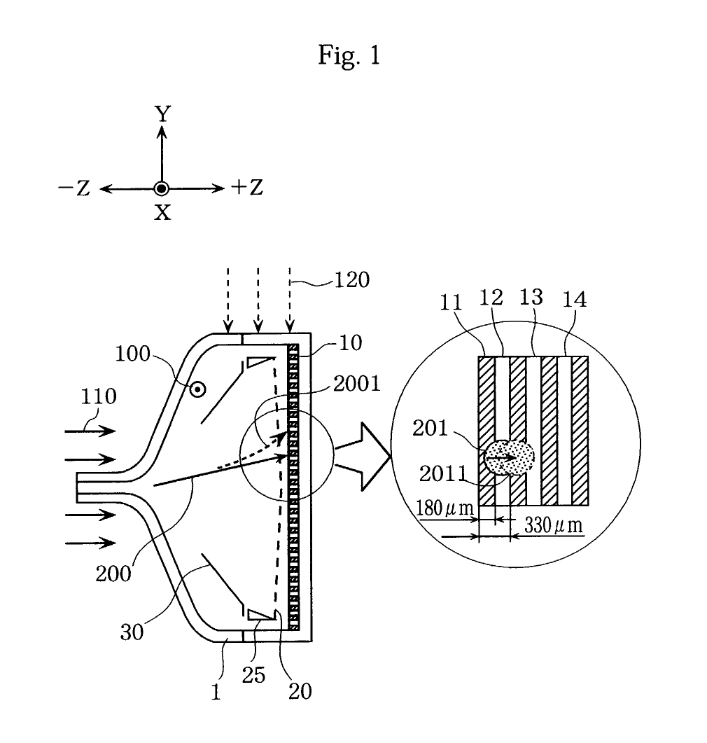

The stripes of fluorescent bands on the display screen extend along Y axis, namely, in the vertical direction, as shown in FIG. 1. Therefore, it is not necessary to consider the deviations of the arrival point in the Y direction as well as forces which cause such deviation. Of course, it is not necessary to consider also forces in the Z direction. The force which should be considered is the force fx which causes a deviation of the arrival point in the X direction. The force fx is given by

fx=|q|(BzVy−ByVz)

where q is the charge of electron; Bz, By are respectively Z and Y components of the magnetic field; Vy, Vz are respectively Y and Z components of the velocity of the electron, as well known by those skilled in the art.

Such properties of deviation of arrival point as well as the flow of the magnetic flux are considered in the analysis for compensation of the deviation in a cathode ray tube for use of color display.

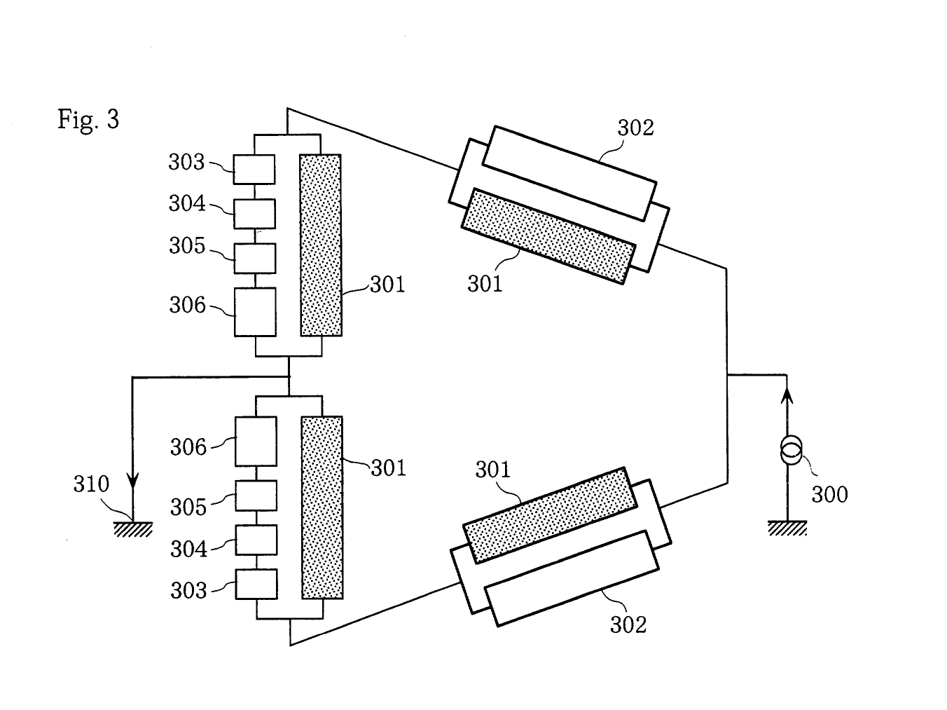

The frame of mask is made from magnetic material. Thus, in the analysis of the magnetic flux, it is convenient to use a magnetic equivalent circuit, usually including the inner magnetic shield. In the magnetic equivalent circuit, a notion of magnetic resistance is used. The magnetic flux having a density and a direction is thought as a flow, which is analogous to an electric current flowing in a resistor or to a fluid flowing in a hydraulic resistor. Also in this system the duality principle stands, which stands among the mechanical system containing a mass, spring and damper; the hydraulic system containing a fluid, hydraulic resistor and reservoir; and the electromagnetic system containing a current, resistor. The equivalent circuit is shown in FIG. 3.

Now, the magnetic field in the Z axis is considered. Thus, the inner magnetic shield 30 and the upper and lower halves of each of the frame 25 and the mask 22 are considered as electric resistance connected in series. The magnetic flux source, which is denoted by 300 in the drawing, corresponds to a current source. Reference numeral 301 is a magnetic resistance of the vacuum. Reference numeral 302 denotes a magnetic resistance of either of the upper or lower halves of the shield. Reference numeral 303 denotes a magnetic resistance of the frame. Reference numeral 304 denotes a magnetic resistance of the welding portion such as between the mask and the frame. Reference numeral 305 denotes an added magnetic resistance due to the elongation of the mask magnetostriction. Reference numeral 306 denotes a magnetic resistance of the mask. Reference numeral 310 is the center portion of the display screen, which corresponds to the ground

The source of the magnetic flux, which corresponds to the electric current, is the terrestrialmagnetic field. Thus the terrestrialmagnetic flux can be thought as a current source (source of magnetic flux). The magnetic flux, which comes from the back of the cathode ray tube near to the electron gun region, flows through the upper resistance and lower resistance connected respectively in series to fall into the center portion of the display screen, which corresponds to the ground in an electromagnetic system. According to actual experiments, it is verified that the edge portion of the inner magnetic shield is a suction region of the magnetic flux inside the inner magnetic shield. It is also verified that the magnetic flux is oppositely flowed at the center portion of the display screen.

The magnetic flux in the vacuum magnetic resistance, in other words, the magnetic flux near to a magnetic material, can be thought as a magnetic flux leaked from the magnetic material. A hard magnetic material, for example, the frame of the mask, is hard to magnetize, when the magnetic field is so weak as the terrestrialmagnetic field. Namely the magnetic resistance of a hard magnetic material is higher than that of a soft magnetic material, for example, the inner magnetic shield. Therefore, a greater part of the magnetic flux flown through the inner magnetic shield flows into the vacuum magnetic resistance, which is connected parallel to the frame of the mask. In other expression, the much magnetic flux leaks, more exactly saying, floods out to the space in the mask.

Such magnetic resistance cannot be easily calculated. The textbook of the electromagnetism teaches that the magnetic resistance can be estimated by

Rm=L/(μS)

where L is the length of a specimen, and S is the area of the cross section of the specimen. However, the value of permeability μ is not a proper value of the used material, but changes complicatedly depending upon many parameters, such as, location, magnitude of the imposed magnetic field, etc. Therefore, there is no way other than to rely upon such analysis and experiments in a greater part in designing an actual apparatus.

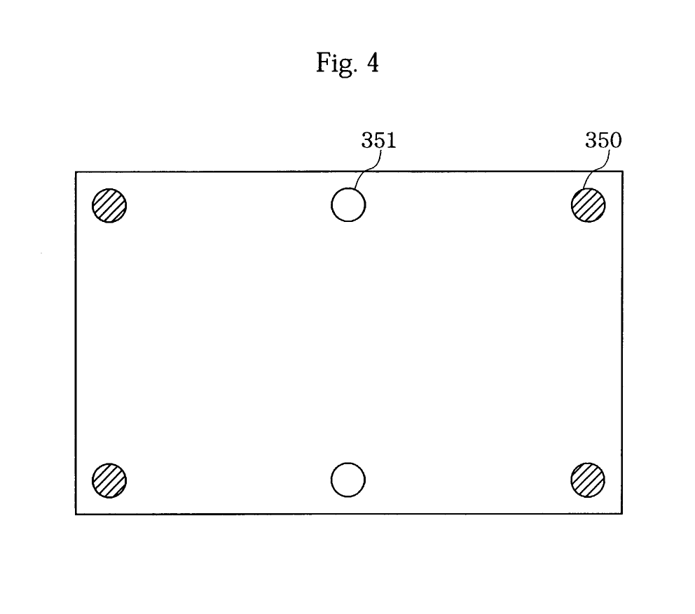

The compensation, which is carried out by such analysis and experiments, is estimated usually by the transverse deviation of the electron beam at three points on the display screen, which are shown in FIG. 4. By the way, actual terrestrialmagnetic field changes, depending upon day and time. Thus the actual measurement is not carried out in the natural terrestrialmagnetic field, but carried out in a laboratory environment where the natural terrestrialmagnetic field is cancelled out and an external (artificial) magnetic field corresponding to the terrestrialmagnetism is given instead.

A set of data is named as a “transverse-corner”, “an axial-corner” and “an axial-NS”. The “transverse-corner” is a deviation measured at tile South East corner of the display screen, which is shown by reference numeral 350 in the drawing, when magnetic fields in the X, Y directions are applied. The “axial-corner” is a deviation measured at the South East corner of the display screen, which is shown by reference numeral 350 in the drawing, when magnetic fields in the Y, Z directions are applied. The “axial-NS” is a deviation measured at the center portion of the long side of the display screen, which is shown by reference numeral 351 in the drawing, when magnetic fields in the Y, Z directions are applied.

For example, the “transverse-corner” is an average of the deviation of the electron beam at the South East corner of the display screen, when a magnetic field, having Y axis component of −0.35 Oe and X axis static component of 0.3 G, is applied.

The “axial-corner” is an average of the deviation of the electron beam at the South East corner of the display screen, when a magnetic field, having Y axis component of −0.35 Oe and Z axis static component of 0.3 G, is applied.

The “axial-NS” is an average of the deviation of the electron beam at the center portion of the long side of the display screen, when a magnetic field, having Y component of −0.35 Oe and Z static component of 0.3 G, is applied.

The measured data comprised of the “transverse-corner”, “axial-corner” and the “axial-NS” are expressed by a set of values in a parentheses, for example,

(20 μm, 45 μm, 40 μm).

The set of values comprises data indicating the degree of the deviation relating to a certain magnetic structure in a cathode ray tube.

The deviation of the electron beam measured as a “transverse corner” relates directly to the blur in a stripe structured fluorescent display. The deviation is compensated as follows.

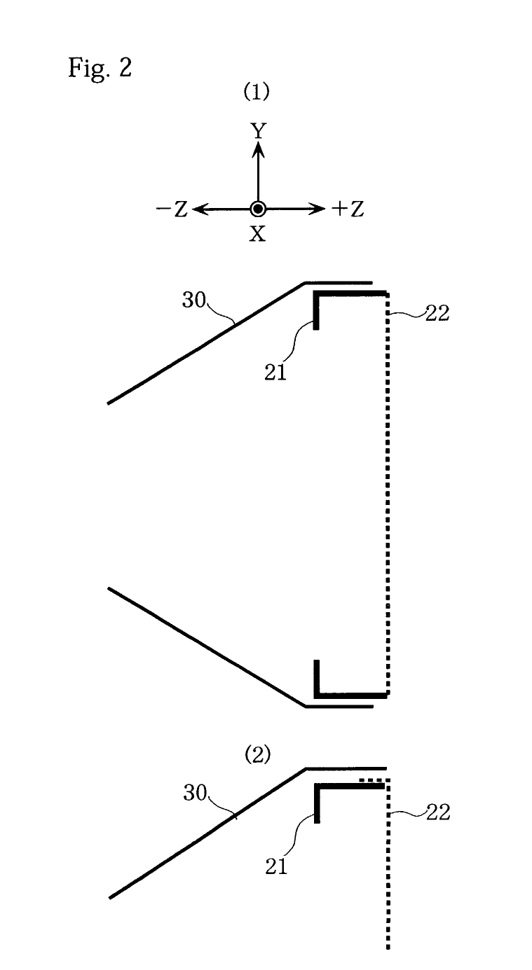

The deviation of electron beam is measured at each of the measuring points, disposing a conventional inner magnetic shield to a steel mask and frame, as in FIG. 2. For example, when the length of the mask, bridging a pair of sides of the frame, is 25 inches, and the thickness of the cathode lay tube is about 10 inches, the obtained data is,

(20 μm, 45 μm, 40 μm).

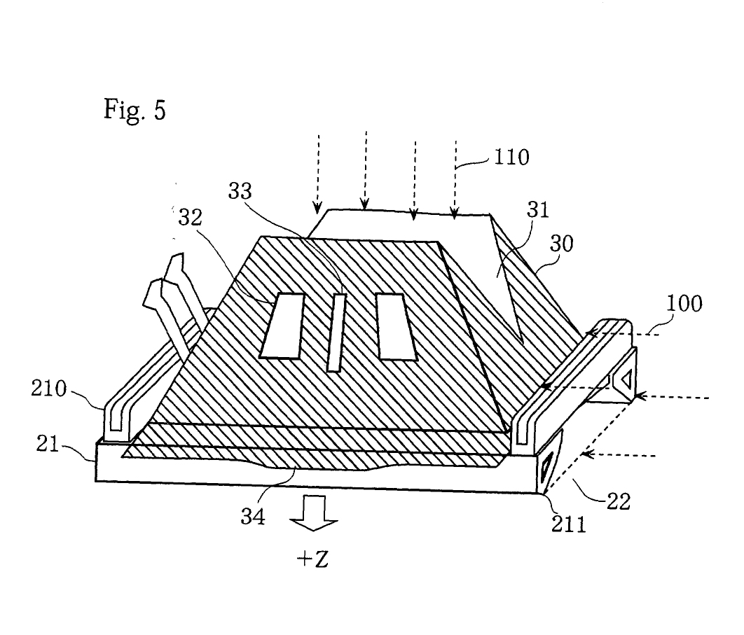

Such deviations are too large. The end cross section of the inner magnetic shield 30 is formed as a rectangular analogous to the form of the display screen 10. And the inner magnetic shield comprises four planes, each of which contacts one of the long sides 21 or the short sides 210 of the frame 25 for the mask 22. In order to decrease such deviations, according to the present invention, a recess 31 is disposed at the center portion of each of the two planes of the inner magnetic shield 30, which is adjacent to one of the short sides 210 of the frame 25, as shown in FIG. 5. The recess has a width of about 80 mm and a depth of 150 mm. By the way, other recesses 32 and 33 are recesses for adjusting the inner magnetic field, which are equipped in a conventional cathode ray tube. In FIG. 5, reference numerals 110 and 100 are respectively a magnetic field in the axial direction and a magnetic field in the transverse direction. Also a mask 22 is shown therein.

Due to this recess 31, the inner magnetic field in the deviation compensation direction is enforced. And the deviation in “axial-corner” drastically decreases. For example, following data are obtained:

(21 μm, 1 μm, 23 μm)

The reason of this effect may be explained as follows: The magnetic flux in the cathode ray tube is separated into two paths due to the recesses 31, as shown in FIG. 3, so that the leakage of the magnetic flux to the inside of the mask 22 is decreased.

Although the compensation is improved somewhat by this countermeasure, it is not sufficient. The deviation in “transverse-corner” is not less than 20 μm, and the deviation in “axial-corner” is too small, namely there is an unbalance among those deviations. Planes of the inner magnetic shield 30 have a cover portion at its end. Short side cover portions of the inner magnetic shield are adjacent to one of the short side 210 of the frame 25. According to the present invention, both the ends of each of the short side cover portions of the inner magnetic shield is welded with the corresponding short side 210 of the frame 25, which supports the long sides 21 of the frame 25. And a gap 23 is formed between the end of the each of the long side cover portion of the inner magnetic shield 30 and the corresponding long sides 21 of the frame 25. The dimension of the gap is about 2 cm in the axial direction of the cathode ray tube. As an effect of this structure, the deviation in “axial-corner” can be increased, simultaneously the deviation in “transverse-corner” can be decreased, and the deviation in “axial-NS” can be maintained to be substantially constant. By the way, reference numeral 211 shown in FIG. 5 denotes a cover of the end portion of the long side 21 of the frame 25.

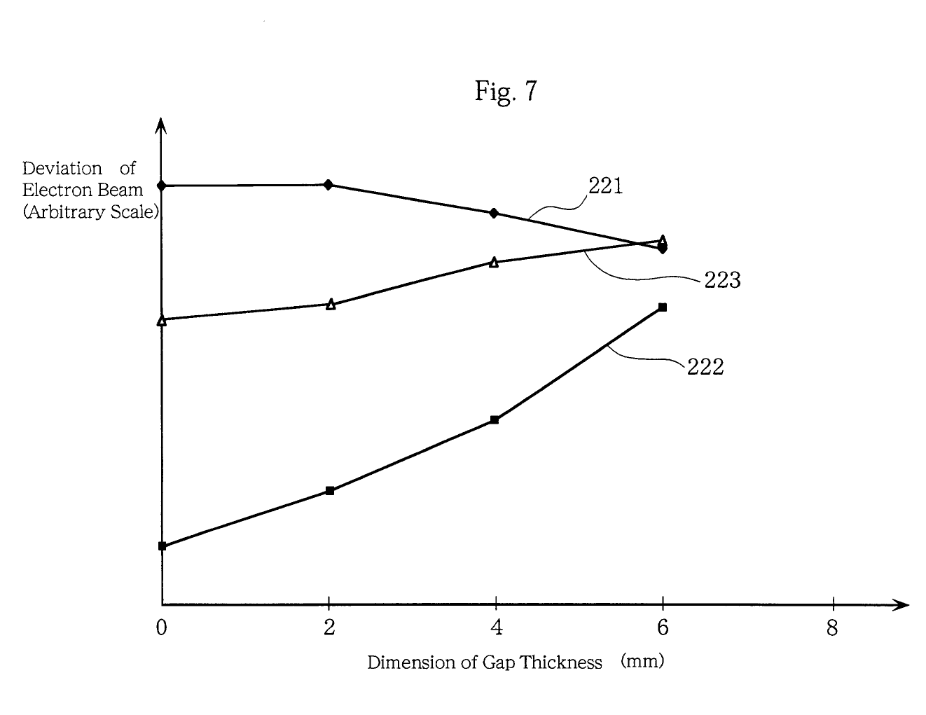

Data obtained in this structure are shown in FIG. 7. The data of the deviations in “transverse-corner” are shown by the curve 221. The data of the deviations in “axial-corner” are shown by the curve 222. The data of the deviations in “axial-NS” are shown by the curve 223.

It is apparent from this graph that the deviation in transverse-corner 221 is improved from 21 μm to 17 μm, when the dimension of the gap 23 between each of the long side cover portions of the inner magnetic shield and corresponding long side 21 of the frame 25 is about 6 mm. Accompanying this improvement, the deviation in axial-corner 222 is deteriorated, however, such deviation lower than 15 μm is allowable. The deviation in “axial-NS” shifts from 23 μm to 25 μm. However, the change is small. All these deviations of the electron beam are deteriorated, when the thickness of the gap 23 is not less than 10 mm.

The reason of these effects may be explained as follows:

The inner magnetic shield 30 is magnetized by the imposed external magnetic field. However, not all the magnetic flux from the inner magnetic shield 30 can flow into the portion of the mask 22 and the frame 25, due to the high magnetic resistance at the frame 25 of the mask. Therefore, usually, a part of the magnetic flux leaks out to the space inside the inner magnetic shield 30 at the side of the electron gun. The leakage of the magnetic flux causes a large deviation in transverse-corner.

However, when a gap 23 is disposed respectively at the upper and lower portions of the frame, according to an embodiment of the present invention, a part of the magnetic flux (magnetic flow) from the inner magnetic shield 30 can be flown out to the space outside the inner magnetic shield 30. As a result, the magnetic flux flowing into the space inside the inner magnetic shield decreases somewhat.

Consequently, when the thickness of the gap 23 between the long side of the frame 21 and the long side cover portion of the inner magnetic shield is about 6 mm, the deviations are

(17 μm, 15 μm, 25 μm).

As a result, a balance of the transverse-corner and the axial corner is remarkably improved.

Such improvement can be attained also by disposing a filler 24 made from hard magnetic material having a relatively small relative permeability, instead of a filler made from non-magnetic material or a gap, which has the permeability of the vacuum, namely μ=1. Such improvement are convinced, when the permeability μ of the hard material is

1<μ<1000.

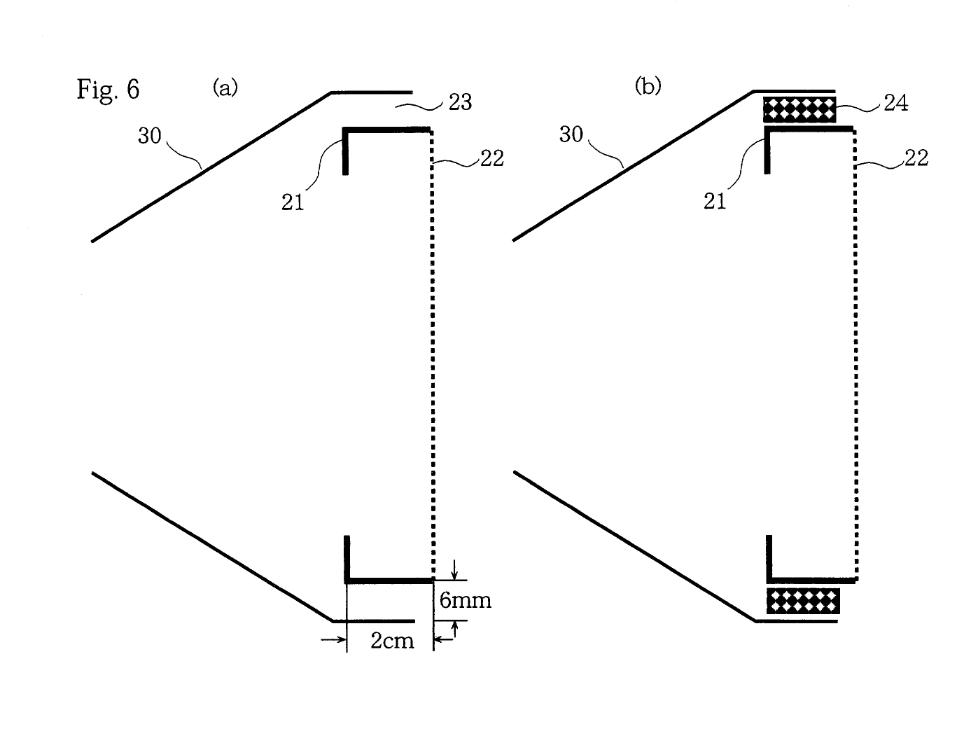

When the relative permeability is not less than 1 to approximately 10, the effect is remarkable and is large at most. FIG. 6(b) shows how a filler 24 made from hard magnetic material is disposed.

When a recess is disposed between the inner magnetic shield and the short side of the frame of mask, as explained hereinbefore, the capability of supporting the structure may decrease. However, the filler 24 can compensate such lowering of the capability.

Although the invention has been described with respect to a preferred embodiment thereof, it will be understood by those skilled in the art that various changes in the form thereof may be made, without departing from the spirit and scope of this invention. For example, following modifications are possible:

1) The invention can be applied to cathode ray tubes, which is not for use of a flat television receiver set, or which is a type of a black-and-white type one and is not a color type one, or which is not a stripe type one and is a delta or mosaic type one.

2) The invention can be applied to cathode ray tubes, the stripe of which extends horizontally, corresponding to the usage environment or usage conditions.

3) The invention can be applied to a future cathode ray tube, in which the fluorescent materials are arranged, considering the influence of the geomagnetism. For example, the width of the stripes is made thin in the end regions, etc.

4) The filler 23 is not always filled along the whole portion of the long sides of the frames (upper and lower sides of the frames), and can be disposed discontinuously.

Industrial Applicability

It is possible to adjust the balance between the deviations in transverse-corner and the axial-corner, maintaining the deviation in axial-NS to be substantially constant, according to the present invention, as explained hereinbefore, by way of an extremely simple structure. And an effective compensation of the terrestrialmagnetic field in the cathode ray tube can be attained, irrespective to the magnetic field of the terrestrialmagnetism.

The mackle and blur at the corners and the center portions near to the upper and lower sides of the display screen disappear, especially from the flat type television receiver having stripes of fluorescent materials.

What is claimed is:

1. A cathode ray tube comprising:
an inner magnetic shield which is made from soft magnetic material, the size of the cross section thereof increases to the fluorescent material display screen direction;
a mask and a frame, which are made from hard magnetic material and are disposed at the inner side of the inner magnetic shield and simultaneously at the electron gun side of a fluorescent material plane; and
a magnetic flux adjusting means for adjusting the magnetic flux, which flows from the inner magnetic shield into the mask, so as to reduce or equalize the deviation of the arrival points of the electron beam onto the display screen, the magnetic flux adjusting means is disposed between the inner magnetic shield and the mask or frame.

2. A cathode ray tube comprising:
an inner magnetic shield which is made from soft magnetic material, the size of the cross, section thereof increases to the fluorescent material display screen direction;
a mask, which is made from hard magnetic material and is disposed at the inner side of the inner magnetic shield, and simultaneously at the electron gun side of a fluorescent material plane, and is disposed at the outer portion of a horizontal side of a frame; and
a structure for magnetism leakage to outside, which is comprised of a gap and/or a filler made from non-magnetic material, the structure for magnetism leakage to outside is disposed between the inner magnetic shield and the mask.

3. A cathode ray tube comprising:
an inner magnetic shield which is made from soft magnetic material, the size of the cross section thereof increases to the fluorescent material display screen direction;
a frame, which is made from hard magnetic material and is disposed at the inner side of the inner magnetic shield and simultaneously at the electron gun side of a fluorescent material plane; and
a structure for magnetism leakage to outside, which is comprised of a gap and/or a filler made from non-magnetic material, the structure for magnetic flux leakage to outside is disposed between the inner magnetic shield and the frame.

4. A cathode ray tube comprising:
an inner magnetic shield which is made from soft magnetic material, the size of the cross section thereof increases to the fluorescent material display screen direction;
a mask, which is made from hard magnetic material and is disposed at the inner side of the inner magnetic shield and simultaneously at the electron gun side of a fluorescent material plane, and is disposed at the outer portion of a horizontal side of a frame; and
a structure for magnetic flux leakage to outside, which is comprised of a filler made from hard magnetic material, or a filler made from hard magnetic material and a gap, or a filler made from hard magnetic material, a gap and a filler made from a non-magnetic material, the structure for magnetic flux leakage to outside is disposed between the inner magnetic shield and the mask.

5. A cathode ray tube comprising:
an inner magnetic shield which is made from soft magnetic material, the size of the cross section thereof increases to the fluorescent material display screen direction;
a frame, which is made from hard magnetic material and is disposed at the inner side of the inner magnetic shield and simultaneously at the electron gun side of a fluorescent material plane; and
a structure for magnetic flux leakage to outside, which is comprised of a filler made from hard magnetic material, or a filler made from hard magnetic material and a gap, or a filler made from hard magnetic material, a gap and a filler made from a non-magnetic material, the structure for magnetic flux leakage to outside is disposed between the inner magnetic shield and the frame.

6. The cathode ray tube according to claims 4 or 5, wherein the hard magnetic material constituting the structure for magnetic flux leakage to outside has a relative permeability μ not less than 1 and not more than 1000.

7. The cathode ray tube according to any one of claims 2 to 5, wherein the cathode ray tube is a stripe type one; and
the dimension of the structure for magnetic flux leakage to outside corresponds to the display screen of the cathode ray tube, and the thickness of the structure is not less than 0.9% and not more than 1.4% of the diagonal dimension of the display screen.

8. The cathode ray tube according to claims 6, wherein the cathode ray tube is a stripe type one; and
the dimension of the structure for magnetic flux leakage to outside corresponds to the display screen of the cathode ray tube, and the thickness of the structure is not less than 0.9% and not more than 1.4% of the diagonal dimension of the display screen.

9. The cathode ray tube according to any one of claims 1 to 5, wherein the display screen is a flat type.

10. The cathode ray tube according to claims 6, wherein the display screen is a flat type.

11. The cathode ray tube according to claims 7, wherein the display screen is a flat type.

12. The cathode ray tube according to claims 8, wherein the display screen is a flat type.
